(19) United States
(12) Patent Application Publication
(10) Pub. No.: US 2011/0112681 A1
(43) Pub. Date: May 12, 2011

(54) VALUABLE MEDIA HANDLING APPARATUS AND VALUABLE MEDIA HANDLING METHOD

(76) Inventors: Koichi Nishida, Hyogo-Ken (JP); Kazuhiro Doi, Hyogo-ken (JP)

(21) Appl. No.: 12/737,386

(22) PCT Filed: Jul. 9, 2008
(86) PCT No.: PCT/JP2008/062412

§ 371 Date: Jan. 7, 2011

(51) Int. Cl. G06F 7/00

(52) U.S. Cl. 700/214

(57) ABSTRACT

A valuable media handling apparatus and a valuable media handling method can complete depositing operation even when a storing unit for storing valuable media becomes full of media in the course of the depositing operation. the valuable media handling apparatus has a taking-in unit to take valuable media into the apparatus, a storing unit to store the taken-in valuable media, a detecting unit to detect that the storing means is full of the valuable media or is nearly full, a returning unit to return, when the detecting unit detects that the storing nit is full of the valuable media or is nearly full while the taking-in unit is taking in the valuable media, the valuable media that are taken-in after the detection to the outside of the apparatus, an information obtaining unit to obtain the information on the valuable media taken in by the taking-in unit, and an information managing unit to manage the information on the valuable media that were taken-in until the storing unit is full of the valuable media or is nearly full as the determinate information and the information on the valuable media returned by the returning unit as the provisional determinate information.

### FIELD OF THE INVENTION

The present invention relates to a valuable media handling apparatus and a valuable media handling method.

### BACKGROUND ART

In a cash room of a department store or a super market, there has been conventionally installed a valuable media handling apparatus that temporarily stores sales proceeds collected from a cash register by a cashier in charge thereof. The valuable media handling apparatus of this type is also installed in a backyard of a store (branch) of a financial institution.

The valuable media handling apparatus is configured to take valuable media, such as banknotes, coins, vouchers or coupon tickets, which are supplied by a person in charge such as a cashier, one by one into the apparatus. Then, the valuable media handling apparatus recognizes and judges denomination, authentication and fitness of the respective valuable media and counts the number thereof. Then, the valuable media handling apparatus temporarily stores the valuable media in a plurality of storing units disposed in the apparatus.

The deposit operation by the person in charge is completed at a time when the person in charge confirms: the types of all the valuable media which have been supplied to the valuable media handling apparatus; the number thereof for each type; and that the number corresponds to the number of the valuable media for each type which has been counted by the valuable media handling apparatus.

Thereafter, the valuable media stored in the valuable media handling apparatus are collected by an accounting staff of a department store or a supermarket or a staff of an armoured car company.

In the valuable media handling apparatus as structured above, there is a possibility that, in the course of taking the valuable media into the apparatus, a part of or all of the storing units for storing valuable media might become full of the valuable media.

In this case, in a conventional valuable media handling apparatus, the taking-in operation of the valuable media is interrupted until the valuable media in the storing units are collected by an accounting staff of a department store or a supermarket or a staff of an armoured car company. Thus, the person in charge cannot complete the deposit operation, and feels inconvenience.

As a technique for solving such a problem, there has been proposed a technique by which the number of banknotes that can be additionally supplied to a banknote deposit apparatus is displayed (see, for example, Patent Document 1 (Japanese Patent Publication No. 8-21106)).

In the technique described in Patent Document 1, the banknote deposit apparatus has a display device for displaying the number of banknotes that can be additionally supplied to the banknote deposit apparatus, which is calculated by deducting the number of deposited banknotes from the maximum storage number of banknotes that can be temporarily stored in an escrow unit for temporarily storing banknotes. Thus, the input operation of banknotes exceeding the storage capacity of the escrow unit can be restricted.

That is to say, in Patent Document 1, the banknote deposit apparatus displays the number of banknotes that can be succeedingly supplied thereto, so as to restrict the deposit operation by the person in charge who would like to deposit the larger number of banknotes than the displayed number of banknotes. Thus, it can be prevented that the person feels inconvenience, which might be caused by the interruption of the deposit operation in the course thereof.

Patent Document 1: Japanese Patent Publication No. 8-21106

### SUMMARY OF THE INVENTION

The above conventional technique (Patent Document 1) can prevent interruption of the deposit operation in the course thereof. However, the person in charge who would like to deposit the number of banknotes exceeding the storage capacity of the escrow unit cannot restart the deposit operation until the banknotes in the escrow unit are collected. Thus, the person in charge cannot promptly complete the deposit operation and still feels inconvenience.

Therefore, the present invention has been made to solve the above disadvantage (problem) of the conventional technique. The object of the present invention is to provide a valuable medium handling apparatus capable of completing a deposit operation, even when a storage unit for storing valuable media, such as banknotes, coins, vouchers or coupon tickets, becomes full in the course of the deposit operation.

In order to solve the aforementioned disadvantage and achieve the object, the invention according to claim 1 is a valuable media handling apparatus for processing valuable media, comprising: a taking-in unit configured to take valuable media supplied from outside into the apparatus; a storing unit configured to store the valuable media taken by the taking-in unit; a detecting unit configured to detect that the storing unit becomes full or nearly full of valuable media; a returning unit configured to return, when the fact that the storing unit has become full or nearly full of valuable media is detected by the detecting unit in the course of the taking-in operation by the taking-in unit, the valuable media which are taken by the taking-in unit after the detection, to the outside of the apparatus; an information obtaining unit configured to obtain valuable media information about the valuable media taken by the taking-in unit; and an information managing unit configured to manage, as determinate information, the valuable media information about the valuable media which have been taken during a time period from a start of the taking-in operation by the taking-in unit until the detection by the detecting unit, and to manage, as provisional determinate information, the valuable media information about the valuable media which have been returned by the returning unit.

In addition, in the invention according to claim 2, the information managing unit includes a memory unit configured to store the valuable media information obtained by the information obtaining unit, and the information managing unit causes the memory unit to store the determinate information and the provisional determinate information.

In addition, in the invention according to claim 3, the valuable media information is information including the number and types of the valuable media taken by the taking-in unit.

In addition, in the invention according to claim 4, the valuable media information is information including a total sum or a total value of the valuable media taken by the taking-in unit.

In addition, in the invention according to claim 5, the valuable media handling apparatus includes a recording medium issuing unit configured to issue a recording medium recording the provisional determinate information.

In addition, in the invention according to claim 6, the valuable media handling apparatus includes; a provisional-determinate-information reading unit configured to read the provisional determinate information from the recording medium issued by the recording medium issuing unit; and a deleting unit configured to, when the provisional determinate information read by the provisional-determinate-information reading unit and the provisional determinate information stored in the memory unit are identical to each other and when valuable media corresponding to the provisional determinate information are taken by the taking-in unit, delete the valuable media information obtained about the taken-in valuable media.

In addition, in the invention according to claim 7, the valuable media handling apparatus includes: a recording medium issuing unit configured to issue a recording medium recording identification information for identifying the provisional determinate information; and an identification-information reading unit configured to read the identification information from the recording medium issued by the recording medium issuing unit; wherein the information managing unit is configured to delete at least a part of or all the information of the valuable media, out of the provisional determinate information corresponding to the identification information read by the identification-information reading unit.

In addition, the invention according to claim 8 is a valuable media handling method including the steps of: taking valuable media supplied from outside into an apparatus; obtaining valuable media information about the valuable media taken into the apparatus; putting the valuable media taken into the apparatus into a storing unit; detecting that the storing unit becomes full or nearly full of valuable media; returning, when it is detected that the storing unit has become full or nearly full of valuable media in the course of taking the valuable media, the valuable media which are taken into the apparatus after the detection, to the outside of the apparatus; managing, as determinate information, the valuable media information about the valuable media which have been taken during a time period from a start of the taking-in operation of the valuable media until the fact that the storing unit has become full or nearly full of valuable media is detected, and managing, as provisional determinate information, the valuable media information about the returned valuable media.

The valuable media handling apparatus according to the present invention includes a taking-in unit configured to take valuable media supplied from outside into the apparatus; a storing unit configured to store the valuable media taken by the taking-in unit; a detecting unit configured to detect that the storing unit becomes full or nearly full of valuable media; a returning unit configured to return, when the fact that the storing unit has become full or nearly full of valuable media is detected by the detecting unit in the course of the taking-in operation by the taking-in unit, the valuable media which are taken by the taking-in unit after the detection, to the outside of the apparatus; an information obtaining unit configured to obtain valuable media information about the valuable media taken by the taking-in unit; and an information managing unit configured to manage, as determinate information, the valuable media information about the valuable media which have been taken during a time period from a start of the taking-in operation by the taking-in unit until the detection by the detecting unit, and to manage, as provisional determinate information, the valuable media information about the valuable media which have been returned by the returning unit. Thus, even when the storing unit becomes full or nearly full of valuable media in the course of taking in the valuable media, information about the valuable media which are taken thereafter can be managed as provisional determinate information. Therefore, even when the storing unit becomes full or nearly full of valuable media in the course of taking in the valuable media, the deposit operation can be completed by using the provisional determinate information.

In addition, the information managing unit of the valuable media handling apparatus according to the present invention includes a memory unit configured to store the valuable media information obtained by the information obtaining unit, and the information managing unit causes the memory unit to store the determinate information and the provisional determinate information. Thus, based on the determinate information and the provisional determinate information, the valuable media information of the valuable media which have been supplied to the valuable media handling apparatus, and the valuable media information obtained by the valuable media handling apparatus, can be checked up (verified) with each other. Therefore, even when the storing unit becomes full or nearly full of valuable media in the course of the deposit operation, the deposit operation can be completed.

In addition, in the valuable media handling apparatus according to the present invention, the valuable media information is information including the number and types of the valuable media taken by the taking-in unit. Thus, even when the storing unit becomes full or nearly full of valuable media in the course of the deposit operation, since the numbers and the types of all the valuable media having been taken into the valuable media handling apparatus can be obtained, the deposit operation can be completed.

In addition, in the valuable media handling apparatus according to the present invention, the valuable media information is information including a total sum or a total value of the valuable media taken by the taking-in unit. Thus, even when the storing unit becomes full or nearly full of valuable media in the course of the deposit operation, since a total sum or a total value of all the valuable media having been taken into the valuable media handling apparatus can be obtained, the deposit operation can be completed.

In addition, the valuable media handling apparatus according to the present invention includes a recording medium issuing unit configured to issue a recording medium recording the provisional determinate information. Thus, the valuable media that have not been stored but returned, and the provisional determinate information about the valuable media, can be managed being associated with each other, by means of the issued recording medium.

In addition, the valuable media handling apparatus according to the present invention includes; a provisional-determinate-information reading unit configured to read the provisional determinate information from the recording medium issued by the recording medium issuing unit; and a deleting unit configured to, when the provisional determinate information read by the provisional-determinate-information reading unit and the provisional determinate information stored in the memory unit are identical to each other and when valuable media corresponding to the provisional determinate information are taken by the taking-in unit, delete the valuable media information obtained about the taken-in valuable media. Thus, when the valuable media which have been once taken to the inside by the taking-in unit and returned by the returning unit are taken to the inside again, the redundant valuable media information obtained from the valuable media can be deleted.

In addition, the valuable media handling apparatus according to the present invention includes: a recording medium issuing unit configured to issue a recording medium recording identification information for identifying the provisional determinate information; and an identification-information reading unit configured to read the identification information from the recording medium issued by the recording medium issuing unit; wherein the information managing unit is configured to delete at least a part of or all the information of the valuable media, out of the provisional determinate information corresponding to the identification information read by the identification-information reading unit. Thus, even when there are plural types of provisional determinate information for each type of the valuable media, for example, since the provisional determinate information of plural types can be easily managed by using identification information assigned to each provisional determinate information, the provisional determinate information can be reliably deleted.

In addition, a valuable media handling method according to the present invention includes the steps of: taking valuable media supplied from outside into an apparatus; obtaining valuable media information about the valuable media taken into the apparatus; putting the valuable media taken into the apparatus into a storing unit; detecting that the storing unit becomes full or nearly full of valuable media; returning, when it is detected that the storing unit has become full or nearly full of valuable media in the course of taking the valuable media, the valuable media which are taken into the apparatus after the detection, to the outside of the apparatus; managing, as determinate information, the valuable media information about the valuable media which have been taken during a time period from a start of the taking-in operation of the valuable media until the fact that the storing unit has become full or nearly full of valuable media is detected, and managing, as provisional determinate information, the valuable media information about the returned valuable media. Thus, even when the storing unit becomes full or nearly full of valuable media in the course of the deposit operation, the deposit operation can be completed.

### BRIEF DESCRIPTION OF THE DRAWINGS

FIG. 1 is an overall structural view of a deposit and dispense apparatus in one embodiment;

FIG. 2 is a view for explaining an example of display by the deposit and dispense apparatus in this embodiment;

FIG. 3 is a functional block view of the deposit and dispense apparatus in this embodiment;

FIG. 4 is a flowchart showing a process performed by the deposit and dispense apparatus in this embodiment; and

FIG. 5 is a flowchart showing a process performed by the deposit and dispense apparatus in this embodiment.

### BEST MODE FOR CARRYING OUT THE INVENTION

1 deposit and dispense apparatus
2 handling machine
3 terminal
11 display and operation unit
12 main control unit
21 sub control unit
22 to 24 storing units for each denomination
22a to 24a full-state detection sensors

A preferred embodiment of a valuable media handling apparatus and a valuable media handling method according to the present invention will be described herebelow with reference to the accompanying drawings.

Given in this embodiment as an example to describe the present invention is a case where the present invention is applied to a deposit and dispense apparatus configured to deposit, store and dispense banknotes. However, the present invention is not limited thereto, but can be applied to another valuable media handling apparatus configured to take in, feed and store given valuable media, such as coins, vouchers or coupon tickets.

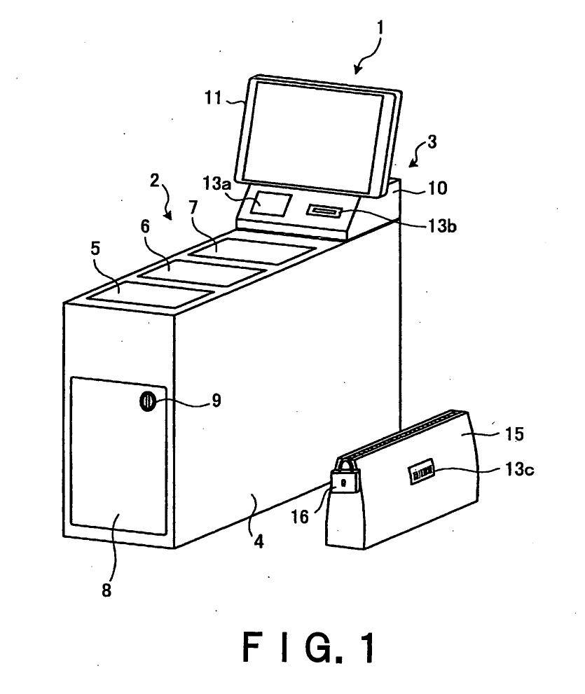

The deposit and dispense apparatus 1 shown in FIG. 1 is an apparatus that is usually installed in a cash room of a department store or a super market, or in a backyard of a store (branch) of a financial institution.

The deposit and dispense apparatus 1 is used for counting sales proceeds of the day, which have been collected and deposited by a cashier or an accounting staff (hereinafter referred to as “person in charge”) after business hours of the store, and/or for temporarily storing the deposited banknotes. In addition, the deposit and dispense apparatus 1 is configured to dispense a banknote when a banknote is needed, for example, when change comes short.

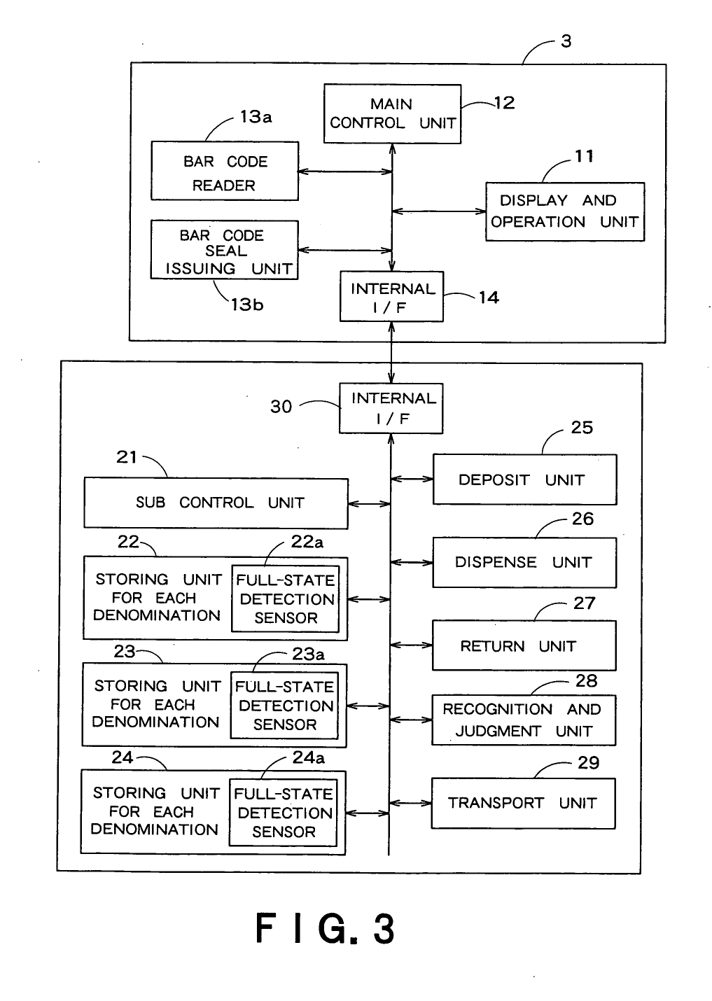

As shown in FIG. 1, the deposit and dispense apparatus 1 includes a handling machine 2 and a terminal 3 that controls an operation of the handling machine 2. The handling machine 2 is configured to perform: a deposit process in which banknotes, which have been supplied by a person in charge, are taken to the inside, the banknotes are counted, recognized and judged, and thereafter the banknotes are temporarily stored in storing units for each denomination (see, FIG. 3) provided inside; and a dispense process in which banknotes stored inside are fed to the outside.

The handling machine 2 has a box-like housing 4. In an upper surface of the box-like housing 4, there are provided an inlet 5 through which a person in charge supplies banknotes, an outlet 6 through which banknotes are fed to the person in charge, and a return slot 7 through which banknotes out of the banknotes taken to the inside, which cannot be stored in the handling machine 2, are returned, in this order from the front side. In addition, a front side surface of the housing 4 is provided with a door 8 that is opened and closed when the banknotes stored in the handling machine 2 are collected and/or the handling machine 2 is replenished with banknotes. The reference number 9 in FIG. 1 is a key hole by which the door 8 is locked and unlocked.

Accommodated inside the housing 4 of the handling machine 2 are a sub control unit 21, storing units for each denomination 22 to 24, a deposit unit 25, a dispense unit 26, a return unit 27, a recognition and judgment unit 28, a transport unit 29, an internal I/F (interface) 30 (see, FIG. 3), and so on, which are described herebelow.

The banknotes temporarily stored in the storing units for each denomination 22 to 24 are thereafter collected by an accounting staff of a department store or a supermarket or a staff of an armoured car company. At this time, the collector collects the banknotes together with the storing units for each denomination 22 to 24 from the handling machine 2, and loads other vacant storing units for each denomination 22 to 24 into the handling machine 2.

The terminal 3 has a body 10 accommodating a main control unit 12 (see, FIG. 3), which is described below, and a display and operation unit 11 of a touch panel type. The display and operation unit 11 displays an instruction image for instructing how to operate the deposit and dispense apparatus 1 to a person in charge, based on a control of the main control unit 12, and causes the handling machine 2 to perform various processes such as the deposit process and the dispense process, when the person in charge touches a predetermined position on the image with his or her finger.

In accordance with an operation of the display and operation unit 11 by the person in charge, the deposit and dispense apparatus 1 is configured to perform the deposit process including a series of processes: a taking-in process in which banknotes supplied to the inlet 5 are taken to the inside, a recognition and judgment process in which denomination, authentification and fitness of the banknotes having been taken to the inside are recognized and judged; a count process in which the banknotes, which have been recognized and judged, are counted for each denomination, and a total sum thereof is calculated; and a storing process in which the counted banknotes are put into the storing units for each denomination 22 to 24. Finally, a total amount for each denomination of the supplied banknotes is displayed on the display and operation unit 11, such that the person in charge can confirm the total amount.

The deposit operation by the person in charge is completed when he/she checks up the total amount for each denomination of the banknotes that have been supplied to the deposit and dispense apparatus 1, with the total amount for each denomination displayed on the display and operation unit 11, and confirms that the amounts correspond to each other.

In particular, even when a part of or all of the inside storing units for each denomination 22 to 24 become(s) full or nearly full of banknotes in the course of taking supplied banknotes to the inside, the deposit and dispense apparatus 1 in this embodiment is configured to continue the deposit process of the already supplied banknotes, so as to complete the deposit operation of the person in charge.

That is to say, even when a part of or all of the storing units for each denomination 22 to 24 become(s) full or nearly full of banknotes in the course of taking banknotes to the inside, the deposit and dispense apparatus 1 is configured to continue the taking-in process of banknotes until the recognition and judgment process and the count process of all the supplied banknotes are finished, and to return banknotes that cannot be stored in the storing units for each denomination 22 to 24 to the person in charge from the return slot 7.

The deposit and dispense apparatus 1 manages, as determinate information, information (valuable media information) relating to banknotes (valuable media) which is obtained from the results of the recognition and judgment process and the count process of banknotes, which have been taken to the inside from the start of the taking-in operation of the banknotes until the storing units for each denomination 22 to 24 become full or nearly full of banknotes. In addition, the deposit and dispense apparatus 1 manages, as provisional determinate information, information (valuable media information) relating to money (valuable media) which is obtained from the results of the recognition and judgment process and the count process of banknotes (returned banknotes), which have been taken to the inside after the storing units for each denomination 22 to 24 became full or nearly full of banknotes. The determinate information and the provisional determinate information are managed separately from each other.

In this embodiment, both the determinate information and the provisional determinate information are managed by the deposit and dispense apparatus 1. However, the determinate information and the provisional determinate information may be managed by another apparatus other than the deposit and dispense apparatus 1.

When such a structure is employed, a predetermined server (e.g., a host computer) connected to the deposit and dispense apparatus 1 via a communication line is further provided. The determinate information and the provisional determinate information are transmitted from the deposit and dispense apparatus 1 to the server, so that a paper sheet management system for managing the determinate information and the provisional determinate information is established by the server.

Due to this establishment of the paper sheet management system, the determinate information and the provisional determinate information about the plurality of deposit and dispense apparatuses 1 can be totally managed by the single server, whereby the management of information on deposit and dispense can be facilitated. Further, since each deposit and dispense apparatus 1 is not required to manage the determinate information and the provisional determinate information in the apparatus by itself, the process load can be reduced.

In this embodiment, since the deposit and dispense apparatus 1 that handles money is taken by way of example as the valuable media handling apparatus, the valuable media information is described as the number of banknotes for each denomination, which have been taken into the deposit and dispense apparatus 1, and a total amount thereof. However, when the present invention is applied to an apparatus that handles coupon tickets or vouchers, the valuable media information is information including a total amount or a total value for each kind of coupon tickets or vouchers which have been taken into the apparatus.

As described above, even when a part of or all of the storing units for each denomination 22 to 24 become(s) full or nearly full of banknotes in the course of taking banknotes to the inside, the deposit and dispense apparatus 1 in this embodiment can complete the recognition and judgment process and the count process of all the banknotes supplied to the deposit and dispense apparatus 1 including returned banknotes, and can manage information obtained as a result of these processes as the determinate information and the provisional determinate information. Thus, the person in charge can complete the deposit operation. Returned money designated in the deposit processes is temporarily stored in a predetermined storing bag 15 equipped with a key 16.

In addition, the deposit and dispense apparatus 1 is provided with a bar code seal issuing unit 13b that converts, to a bar code, information on the banknotes that could not be stored in the storing units for each denomination 22 to 24 but returned (information on the number of the banknotes for each denomination and a total amount thereof), and issues a bar code seal 13c that records the information as the bar code.

In this embodiment, the bar code seal issuing unit 13b functions as a recording medium issuing unit for issuing a recording medium (bar code seal 13c in this embodiment) recording the provisional determinate information.

When the banknotes that could not be stored in the storing units for each denomination 22 to 24 but were returned are temporarily stored in the storing bag 15, the bar code seal 13c issued from the bar code seal issuing unit 13b is attached to the storing bag 15. Thus, when the cash stored in the storing bag 15 is thereafter collected and confirmed, it is easy to confirm the cash, by reading from the bar code seal 13c information on the number of (returned) banknotes for each denomination and the total amount thereof, which information corresponds to the provisional determinate information recorded in the bar code seal 13c.

In addition, the deposit and dispense apparatus 1 is provided with a bar code reader 13a that reads the provisional determinate information recorded as a bar code in the bar code seal 13c.

In this embodiment, the bar code reader 13a functions as a provisional-determinate information reading unit for reading the provisional determinate information from the recording medium issued by the recording medium issuing unit.

The bar code reader 13a is used in the following timing. Namely, upon completion of the deposit operation by the person in charge, returned money (banknotes that could not be stored in the storing units for each denomination 22 to 24) is designated. Thereafter, when the storing units for each denomination 22 to 24 become capable of storing banknotes, the bar code reader 13a is used and then the returned money is supplied again to the deposit and dispense apparatus 1 so as to be stored in the storing units for each denomination 22 to 24.

That is to say, suppose that, upon completion of the deposit operation by the person in charge, returned money is designated and spare storing units for each denomination are prepared. In this case, when the person in charge replaces the storing units for each denomination 22 to 24 that are full or nearly full of banknotes with the spare storing units for each denomination, the deposit and dispense apparatus 1 can again take thereinto the returned money, so that the returned money can be put into the spare storing units for each denomination.

In this case, the person in charge holds the bar code seal 13c over the bar code reader 13a to input the provisional determinate information on the returned money (the number of returned banknotes for each denomination and a total amount thereof) to the deposit and dispense apparatus 1. Then, the person in charge again inputs the returned money to the deposit and dispense apparatus 1.

The deposit and dispense apparatus 1 takes to the inside the resupplied returned money (banknotes). The banknotes are again subjected to the recognition and judgment process and the count process, and are put into the storing units for each denomination.

At this time, the deposit and dispense apparatus 1 has already performed the count process of the resupplied banknotes, before the banknotes are returned. Thus, when the count process is performed again to the resupplied banknotes, the banknotes are redundantly subjected to the count process (double counting).

In order to avoid this, the deposit and dispense apparatus 1 in this embodiment is configured as follows. Namely, before the returned money, which has been once subjected to the count process, is again supplied to the deposit and dispense apparatus 1, the person in charge inputs the information on the returned money (the number of banknotes for each denomination and a total amount thereof) by means of the bar code seal 13c. Thereafter, when the returned money is resupplied, it is judged whether the provisional determinate information that has been managed inside the deposit and dispense apparatus 1 and the provisional determinate information read from the bar code seal 13c by the bar code reader 13a are identical to each other or not. If judged as identical to each other, the deposit and dispense apparatus 1 deletes the number of banknotes for each denomination which is included in the provisional determinate information (information on the redeposited banknotes) read by the bar code reader 13a, from the number of banknotes for each denomination which is obtained as a result of the count process to the resupplied banknotes.

Thus, in the deposit and dispense apparatus 1 in this embodiment, the double counting of the resupplied returned money can be prevented, and the returned money can be securely stored in the replaced spare storing units for each denomination.

The deletion process performed when banknotes once returned are resupplied may be a deletion process other than the above process. As long as the double counting caused by the resupply of the banknotes can be avoided, any deletion process may be performed.

For example, when the provisional determinate information is inputted by means of the bar code seal 13c, and then banknotes corresponding to the provisional determinate information are supplied, the deposit and dispense apparatus 1 takes thereinto the banknotes, again performs the count process, and then puts the banknotes into the replaced spare storing units for each denomination. Regarding the banknotes stored at this time, the count result is not added (counted) to the amount of the storing units for each denomination.

However, regarding the banknotes corresponding to the provisional determinate information stored in the replaced spare storage units for each denomination, the number thereof for each denomination is recorded in the below-described main control unit 12 (see, FIG. 3).

At this time, it is possible to perform a deletion process in which the recorded number of resupplied banknotes for each denomination is deducted from the number of banknotes for each denomination corresponding to the provisional determinate information that has been managed inside.

The bar code seal 13c may record the concrete provisional determinate information on the resupplied banknotes for each denomination, such as the number of banknotes, which have been resupplied to the deposit and dispense apparatus 1, and a total amount thereof. Alternatively, the bar code seal 13c may record only an ID as identification information for specifying the provisional determinate information that has been stored and managed inside the deposit and dispense apparatus 1.

When only the ID is recorded on the bar code seal 13c, the deposit and dispense apparatus 1 is structured as follows. Namely, when there is returned money upon completion of the deposit operation by the deposit and dispense apparatus 1, the deposit and dispense apparatus 1 is configured to previously allocate a specific ID to the provisional determinate information on the returned banknotes, and to record and manage the ID and the provisional determinate information being associated with each other. The deposit and dispense apparatus 1 is configured to issue, to the person in charge, the bar code seal 13c recording the ID assigned to the provisional determinate information. In addition to the ID corresponding to the provisional determinate information, the bar code seal 13c may record time information including a completion time of the deposit operation where the returned money is designated.

In addition, when the person in charge inputs the ID to the deposit and dispense apparatus 1 by means of the bar code seal 13c issued from the deposit and dispense apparatus 1, the deposit and dispense apparatus 1 is configured to detect the provisional determinate information corresponding to the inputted ID out of various information that has been managed in the deposit and dispense apparatus 1, and to delete at least a part of or all the information (e.g., information on the number of banknotes for each denomination) included in (overlapped with) the provisional determinate information falling under the ID. The process of deleting the provisional determinate information is performed by the below-described main control unit 12 (see, FIG. 3).

When the deposit and dispense apparatus 1 is structured as above, the bar code seal 13c functions as a recording medium recording identification information for identifying the provisional determinate information, and the bar code seal issuing unit 13b functions as a recording medium issuing unit for issuing the recording medium recoding the identification information. In addition, in this case, the bar code reader 13a functions as an identification-information reading unit for reading the identification information from the recording medium issued by the recording medium issuing unit.

According to the deposit and dispense apparatus 1 as structured above, by allocating a specified ID to every completion time of the deposit operation where returned money is designated and/or to every type of returned banknotes, plural types of provisional determinate information can be easily managed.

In addition, in the deposit and dispense apparatus 1 as structured above, in a case where the provisional determinate information should be deleted, for example, in a case where the returned money is resupplied, even when there are plural types of provisional determinate information, only the particular provisional determinate information can be easily deleted by merely referring to the ID.

Herein, there is described a case in which all the determinate information and the provisional determinate information on the deposited banknotes are managed by the deposit and dispense apparatus 1. However, when a paper sheet management system that manages the determinate information and the provisional determinate information is established by the aforementioned server, the server performs the process for allocating an ID to the provisional determinate information, and the process for recording and managing the ID and the provisional determinate information being associated with each other.

Further, in the paper sheet management system as established above, a control signal for issuing the bar code seal 13c is transmitted from the server to the deposit and dispense apparatus 1, so that the deposit and dispense apparatus 1 issues the bar code seal 13c recording the ID to the person in charge.

In this paper sheet management system, when the person in charge inputs the ID to the deposit and dispense apparatus 1 by means of the bar code seal 13c issued from the deposit and dispense apparatus 1, the deposit and dispense apparatus 1 transmits the ID to the server, the server detects the provisional determinate information corresponding to the inputted ID out of various information managed in the server, and the server deletes at least a part of or all the information (e.g., information on the number of banknotes for each denomination) included in (overlapped with) the provisional determinate information falling under the inputted ID.

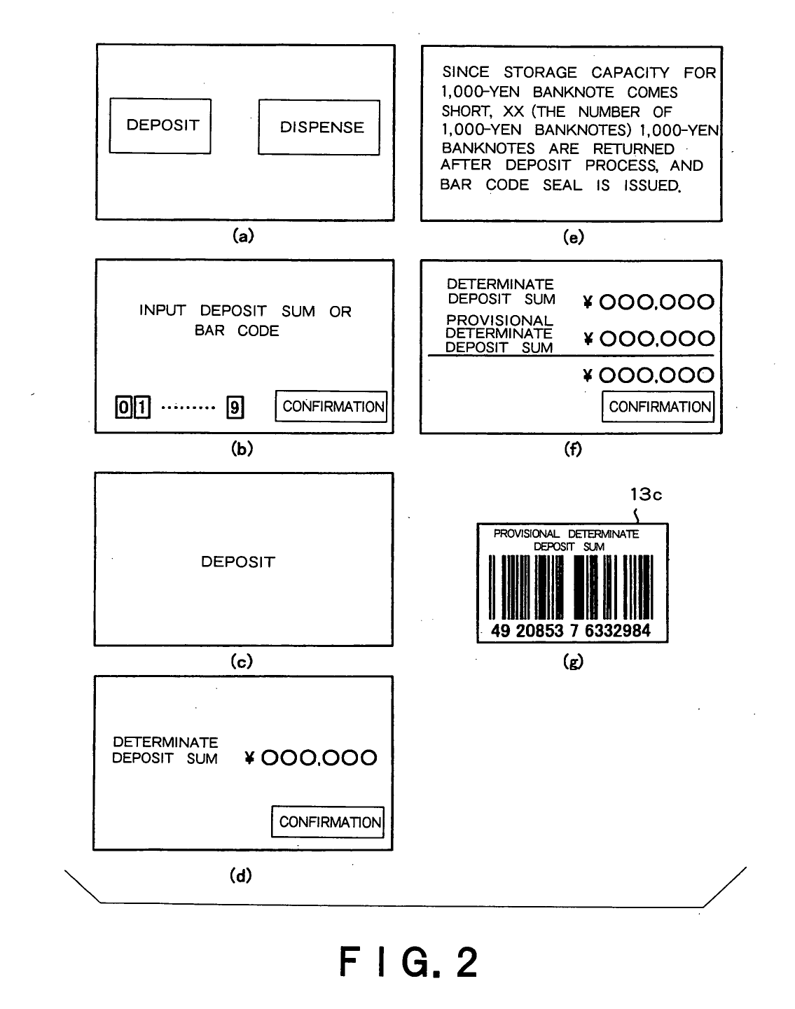

With reference to FIG. 2, a flow of the deposit operation performed by a person in charge and various instruction display images displayed on the display and operation unit 11 of the deposit and dispense apparatus 1 in this embodiment are described.

FIG. 2 is an explanatory view showing examples of instruction images displayed on the display and operation unit 11 of the deposit and dispense apparatus 1, and the bar code seal 13c.

As shown in FIG. 2(a), when a person in charge performs the deposit operation, an instruction image by which one of “Deposit” and “Dispense” is selected by the person in charge is displayed on the display and operation unit 11 of the deposit and dispense apparatus 1.

When the person in charge touches the part where the characters “Deposit” are displayed in the instruction image, as shown in FIG. 2(b), an instruction display image in which “Input deposit sum or bar code” is displayed on the display and operation unit 11.

At this time, when returned money, which has been already subjected to the deposit process, is resupplied, the person in charge holds the bar code seal 13c over the bar code reader 13a of the terminal 3 so as to input the bar code.

Herein, the person in charge does not resupply returned money but deposits banknotes for the first time. Thus, the person in charge inputs a sum of banknotes to be deposited, by touching the numbers of “0” to “9” in the instruction image shown in FIG. 2(b). Thereafter, the person in charge determines the deposit sum by touching the part where the characters “Confirm” are displayed.

After the deposit sum has been determined, the deposit and dispense apparatus 1 judges whether all the banknotes corresponding to the determined deposit sum can be stored or not. When all the banknotes can be stored, as shown in FIG. 2(c), the instruction display image ‘showing “Deposit” is displayed on the display and operation unit 11.

In accordance with the instruction display image, the person in charge supplies the inlet 5 of the deposit and dispense apparatus 1 with all the banknotes collected from a cash register or the like.

When the banknotes are supplied, the deposit and dispense apparatus 1 takes thereinto the banknotes one by one, performs the recognition and judgment process for recognizing and judging, e.g., an authentification, a fitness and a denomination, and the count process to the banknotes, and sequentially puts the banknotes having been subjected to these processes into the storing units for each denomination 22 to 24.

Then, after the recognition and judgment process and the count process to all the banknotes supplied by the person in charge have been finished, and all the banknotes have been stored in the storing units for each denomination 22 to 24, as shown in FIG. 2(d), a total sum calculated as a result of the count process is displayed as a deposited determinate sum on the display and operation unit 11.

On the other hand, when the deposit sum is determined but only a part of the banknotes corresponding to the determined deposit sum can be stored, there is displayed an instruction image informing that a storage capacity of the storing units for each denomination 22 to 24 comes short, that the deposit operation is nevertheless continued, that the banknotes which cannot be stored in the storing units for each denomination 22 to 24 are returned, and that a bar code seal 13c relating to the banknotes is issued.

For example, as shown in FIG. 2(e), there is displayed a instruction display image showing “Since storage capacity for 1,000-yen banknote comes short, XX (the number of 1,000-yen banknotes) 1,000-yen banknotes are returned after deposit process, and bar code seal is issued”.

After that, as shown in FIG. 2(c), an instruction display image showing “Deposit” is displayed on the display and operation unit 11 of the deposit and dispense apparatus 1.

When the banknotes are supplied, the deposit and dispense apparatus 1 takes thereinto the banknotes one by one, and performs the recognition and judgment process for recognizing and judging, e.g., an authentification, a fitness and a denomination, and the count process to the banknotes. Then, the deposit and dispense apparatus 1 puts the banknotes, which can be stored, into the storing units for each denomination 22 to 24, and returns the banknotes, which cannot be stored in the storing units for each denomination 22 to 24, to the outside.

After the recognition and judgment process and the count process to all the banknotes supplied by the person in charge have been finished, as shown in FIG. 2(f), a determinate deposit sum, a provisional determinate deposit sum, and a total sum of them are displayed as an instruction display on the display and operation unit 11.

The determinate deposit sum displayed at this time shows a total sum of the banknotes which have been subjected to the recognition and judgment process and the count process, before the storing units for each denomination 22 to 24 become full or nearly full of banknotes. Namely, the determinate deposit sum is a total sum of the banknotes that could be stored in the storing units for each denomination 22 to 24, out of the banknotes supplied at this time by the person in charge. Although not shown, the number of banknotes for each denomination may be displayed, in addition to the total sum of the determinate deposit sum.

On the other hand, the provisional determinate deposit sum shows a total sum of the banknotes which have been subjected to the recognition and judgment process and the count process, after the storing units for each denomination 22 to 24 became full or nearly full of banknotes. Namely, the provisional determinate sum is a total sum of the banknotes that could not be stored in the storing units for each denomination 22 to 24 and were returned, out of the banknotes supplied at this time by the person in charge. Although not shown, the number of banknotes for each denomination may be displayed, in addition to the total sum of the provisional determinate deposit sum.

The deposit and dispense apparatus 1 separately stores and manages the information on the determinate deposit sum as determinate information, and the information on the provisional determinate deposit sum as provisional determinate information. The deposit and dispense apparatus 1 issues the bar code seal 13c shown in FIG. 2(g), on which the information on the provisional determinate deposit sum is printed as a bar code, from the bar code seal issuing unit 13a.

Thereafter, the person in charge confirms that the total sum of the determinate deposit sum and the provisional determinate deposit sum in the instruction image shown in FIG. 2(f) and the total sum of the banknotes supplied by himself/herself to the deposit and dispense apparatus 1 conform to each other. Then, the person in charge touches the part where the characters “Confirm” are displayed, and receives the bar code seal 13c issued from the bar code seal issuing unit 13a.

As described above, the bar code seal 13c records the provisional determinate information including the number of returned banknotes for each denomination and the total sum thereof corresponding to the provisional determinate deposit sum. Thus, by reading the provisional determinate information from the bar code seal 13c, the banknotes that could not be stored in the deposit and dispense apparatus 1 and were returned can be easily confirmed.

Then, the person in charge puts the banknotes corresponding to the provisional determinate deposit sum, which have been returned from the deposit and dispense apparatus 1, into the storage bag 15, and attaches the bar code seal 13c onto the storage bag 15. At this time, the deposit operation by the person in charge is completed.

According to the deposit and dispense apparatus 1 in this embodiment, even when a person in charge supplies banknotes whose number exceeds the storage capacity of the storing units for each denomination 22 to 24, the person in charge can complete the deposit operation. Moreover, regarding the banknotes that could not be stored in the storing units for each denomination 22 to 24 and were returned, which correspond to the provisional determinate deposit sum, the bar code seal 13c recording the provisional determinate information, such as the number of the banknotes for each denomination and the total sum thereof, is issued. Thus, by reading afterward the information, such as the number of the returned banknotes for each denomination and the total sum thereof, which corresponds to the provisional determinate deposit sum, from the bar code seal 13c, the banknotes corresponding to the provisional determinate deposit sum can be easily confirmed.

When returned money is designated upon completion of the deposit operation by a person in charge, and spare storing units for each denomination are prepared, the person in charge can replace the storing units for each denomination 22 to 24 that are full or nearly full of banknotes, with the spare storing units for each denomination. Thus, the deposit and dispense apparatus 1 can again take thereinto the returned money and put the returned money into the spare storing units for each denomination.

With reference to FIG. 3, the inside structure of the deposit and dispense apparatus 1 capable of performing the above-described deposit operation is described. FIG. 3 is a functional block view of the deposit and dispense apparatus 1 in this embodiment.

As shown in FIG. 3, the deposit and dispense apparatus 1 includes the handling machine 2 and the terminal 3 that controls the operation of the handling machine 2. The handling machine 2 performs the banknote taking-in process, the banknote recognition and judgment process, the banknote storing process, and the banknote return process.

The handling system 2 includes: the deposit unit 25 that takes banknotes supplied by a person in charge to the inside from the inlet 5; the dispense unit 26 that feeds banknotes from the inside to the outlet 6; the return unit 27 that returns banknotes, which have been once taken to the inside, to the return slot 7; the recognition and judgment unit 28 that recognizes and judges the banknotes taken to the inside; the transport unit 29 that transports the banknotes in the handling system 2; the storing units for each denomination 22 to 24 that store banknotes by denomination; the internal I/F 30 that transmits various information to and from the terminal 3; and the sub control unit 21 that controls the operations of the deposit unit 25, the dispense unit 26, the return unit 27, the recognition and judgment unit 28, the transport unit 29, the internal I/F 30, and the storing units for each denomination 22 to 24.

The deposit unit 25 functions as a taking-in unit for taking valuable media supplied from outside into the apparatus, based on a process request received by the below-described internal I/F 30. The deposit unit 25 includes a pair of belts that sandwich banknotes one by one from above and below, and a drive unit having a pulley and a motor for driving the belts. The deposit unit 25 is configured to take a plurality of banknotes, which have been collectively supplied to the inlet, one by one to the inside.

Similarly to the deposit unit 25, each of the dispense unit 26 and the return unit 27 includes a pair of belts and a drive unit having a pulley and a motor for driving the belts. The dispense unit 26 is configured to feed banknotes, which have been transported from the inside, one by one to the outlet 6. The return unit 27 is configured to return banknotes, which have been transported from the inside, one by one from the return slot 7.

In particular, in this embodiment, during the taking-in operation of valuable media by the taking-in unit, when the below-described detecting unit detects that a storing unit of valuable media becomes full or nearly full of valuable media, the return unit 27 functions as a returning unit for returning to the outside the valuable media taken to the inside by the taking-in unit after this detection.

The recognition and judgment unit 28 performs the recognition and judgment process for recognizing and judging an authentification, a fitness and a denomination of banknotes taken to the inside, and performs the count process for counting the number of the recognized and judged banknotes so as to calculate the number of the taken-in banknotes for each denomination and a total sum thereof.

In this embodiment, the recognition and judgment unit 28 functions as an information obtaining unit for obtaining valuable media information on the valuable media taken to the inside by the taking-in unit. Included in the valuable media information obtained by the information obtaining unit are an authentification, a fitness and denomination of respective recognized and judged banknotes, as well as the number of the banknotes for each denomination and a total sum thereof, which are obtained as a result of the count process. The valuable media information is transmitted as a deposit and dispense report to the below-described main control unit 12.

The storing units for each denomination 22 to 24 function as the storing unit for storing the valuable media taken to the inside by the taking-in unit. The storing units for each denomination 22 to 24 are structured as removable stackers that stores banknotes recognized by the recognition and judgment unit 28 for each denomination (specifically, 10,000-yen bill, 5,000-yen bill, and 1,000-yen bill).

The storing units for each denomination 22 to 24 are respectively provided with full-state detection sensors 22a to 24a which detect that the respective stackers become full or nearly full of banknotes. In this embodiment, the full-state detection sensors 22a to 24a function as detecting unit for detecting that the storing unit has become full or nearly full of valuable media.

The transport unit 29 is configured to transport banknotes from the deposit unit 25 to the storing units for each denomination 22 to 24 via the recognition and judgment unit 28, from the storing units for each denomination 22 to 24 to the dispense unit 26 via the recognition and judgment unit 28, and from the deposit unit 25 to the return unit 27 via the recognition and judgment unit 28.

The transport unit 29 has a pair of transport belts extending among the above respective units (the deposit unit 25, the dispense unit 26, the return unit 27, the recognition and judgment unit 28, and the storing units for each denomination 22 to 24) through a plurality of rollers, and a drive unit for driving the transport belts. By driving the pair of transport belts between which banknotes are sandwiched one by one, the banknotes can be transported one by one.

The sub control unit 21 is composed of a CPU (Central Processing Unit), a ROM (Read-Only Memory) and a RAM (Random Access Memory). Based on various process requests transmitted from the below-described main control unit 12, the CPU reads and executes various information processing programs for processing banknotes which are stored in the ROM so as to control the operations of the deposit unit 25, the dispense unit 26, the return unit 27, the recognition and judgment unit 28, and the transport unit 29, whereby the banknote deposit process, the banknote dispense process, the banknote return process and the banknote recognition and judgment process are performed. When the various information processing programs stored in the ROM are executed by the CPU, the RAM functions as a temporary memory area used as a working area.

The reference number 30 in FIG. 3 depicts the internal I/F 30 that transmits various information to and from the terminal 3, the information including various process requests and deposit and dispense reports.

The sub control unit 21, the internal I/F 30, the deposit unit 25, the dispense unit 26, the return unit 27, the recognition and judgment unit 28, the transport unit 29 and the storing units for each denomination 22 to 24 are connected to each other through buses for information communication.

Next, the structure of the terminal 3 is described. The terminal 3 includes an internal I/F 14, the display and operation unit 11 of a touch panel type, the bar code seal issuing unit 13b, the bar code reader 13a, and the main control unit 12. The internal I/F 14 transmits various information to and from the handling machine 2. The bar code seal issuing unit 13b issues a bar code seal 13c on which information on banknotes that could not be stored in the storing units 22 to 24 for each denomination and were returned is written. The bar code reader 13a reads the information printed on the bar code seal 13c. The main control unit 12 controls the operation of the overall deposit and dispense apparatus 1 as well as the operations of the display and operation unit 11, the internal I/F 14 and the bar code seal issuing unit 13b, and the bar code reader 13a.

The main control unit 12 is composed of a CPU, a ROM and a RAM. The ROM stores various information processing programs executed by the CPU, and various image information to be displayed on the display and operation unit 11.

To be specific, the ROM stores: programs to be executed by the CPU so as to transmit various process requests, which includes a request for starting the banknote deposit operation and a request for starting the banknote dispense operation, to the handling machine 2 based on the operation of the display and operation unit 11; and various instruction display images (see, FIG. 2) for instructing the operation of the terminal 3 to a person in charge.

Based on the operation of the display and operation unit 11 by a person in charge, the main control unit 12 is configured to read the various information processing programs stored in the ROM and to execute the programs by using the RAM as a working area, so as to control the total operations of the deposit and dispense apparatus 1, e.g., to control the operation of the handling machine 2 and the display of the display and operation unit 11.

The RAM inside the main control unit 12 stores, as the valuable media information, a result of the banknote count process by the recognition and judgment unit 28 and so on. Information showing the number of banknotes for each denomination, which have been subjected to the count process, and information showing a total amount of the banknotes which have been subjected to the count process, are stored as the valuable media information based on a control of the main control unit 12. In this embodiment, the RAM functions as a memory unit for recording the valuable media information obtained by the information obtaining unit.

In particular, in the main control unit 12, the valuable media information on banknotes, which have been taken to the inside during a time period from a time when the banknote taking-in operation was started until a time when a part of or all of the storing units for each denomination 22 to 24 become(s) full or nearly full of banknotes, is stored as the determinate information, and the valuable media information on banknotes, which have been taken to the inside after a part of or all of the storing units for each denomination 22 to 24 became full or nearly full of banknotes, is stored as the provisional determinate information. The determinate information and the provisional determinate information are stored in separate memory areas in the RAM.

That is to say, in this embodiment, the main control unit functions as an information managing unit for managing: the valuable media information on the valuable media which have been taken to the inside during a time period from the start of the taking-in operation by the taking-in unit until the detection by the detecting unit (the fact that the storing unit becomes full or nearly full by valuable media is detected), as the determinate information; and the valuable media information on the valuable media which have been returned by the returning unit, as the provisional determinate information.

The display and operation unit 11 has a display unit for displaying various instruction images relating to the deposit operation and so on, and a press detecting unit for detecting that a predetermined position in an instruction image is pressed (touched).

Based on the control of the main control unit 12, the display and operation unit 11 displays the various instruction images, and, when a person in charge touches (presses) a process position in an instruction image, transmits a signal corresponding to the pressing operation to the main control unit 12.

The internal I/F 14 is a communication interface that transmits various information to and from the handling machine 2.

The bar code seal issuing unit 13b has a printing unit and a feeding unit. Based on the control of the main control unit 12, the printing unit converts, to a bar code, provisional determinate information (e.g., a result of the recognition and judgment process and a result of the count process) relating to banknotes which were subjected to the recognition and judgment process and the count process but could not be stored in the storing units for each denomination 22 to 24 and were returned, out of banknotes supplied by a person in charge to the handling machine 2, and records (prints) the bar code on a seal member. The feeding unit feeds outside the bar code seal 13c on which the bar code has been printed by the printing unit. In this embodiment, the bar code seal issuing unit 13b functions as a recording medium issuing unit for issuing a recording medium recording the provisional determinate information. The bar code seal 13c corresponds the recording medium recording the provisional determinate information.

The bar code reader 13a has a light irradiating unit for irradiating a laser beam toward the bar code seal 13c held by a person in charge, and a decoding unit for decoding the provisional determinate information from the bar code based on a reflected light beam that is the beam irradiated from the light irradiating unit and reflected by the bar code. The bar code reader 13a transmits the decoded provisional determinate information to the main control unit 12.

Namely, based on the control of the main control unit 12, the bar code reader 13a reads the provisional determinate information from the bar code seal 13c, and causes the RAM in the main control unit 12 to store the provisional determinate information. In this embodiment, the bar code reader 13a functions as a provisional-determinate information reading unit for reading provisional determinate information from the recording medium issued by the recording medium issuing unit.

When the provisional determinate information read out by the provisional-determinate information reading unit (bar code reader 13a) and the provisional determinate information that has been stored in the memory unit (ROM in the main control unit 12) are identical to each other, and valuable media corresponding to just the provisional determinate information are taken by the taking-in unit, the information obtaining unit (recognition and judgment unit 28) is configured to cancel (delete) the valuable media information (the number of resupplied banknotes for each denomination) obtained based on the taken-in valuable media.

That is to say, when there is an input of a bar code, and banknotes which were subjected to the recognition and judgment process and the count process but could not be stored in the storing units for each denomination 22 to 24 and were returned are again supplied to the deposit and dispense apparatus 1, the recognition and judgment unit 28 is configured to invalidate the count result of the resupplied banknotes.

The main control unit 12, the display and operation unit 11, the internal I/F 14, the bar code reader 13a and the bar code seal issuing unit 13b are connected to each other through communication buses.

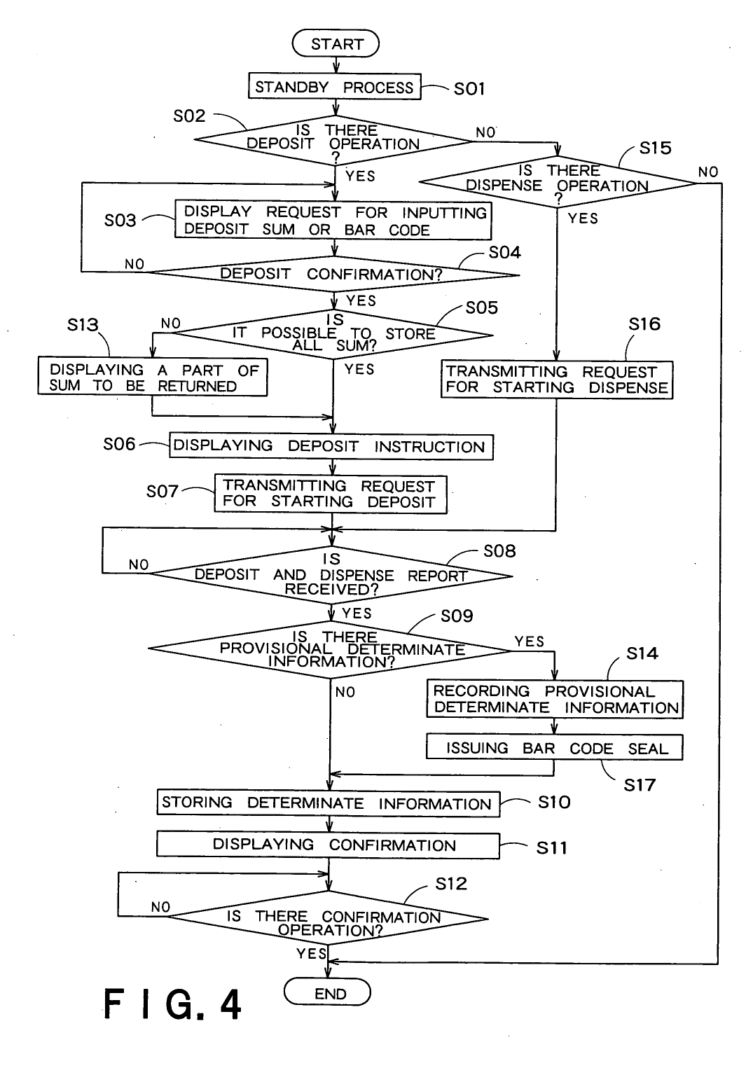

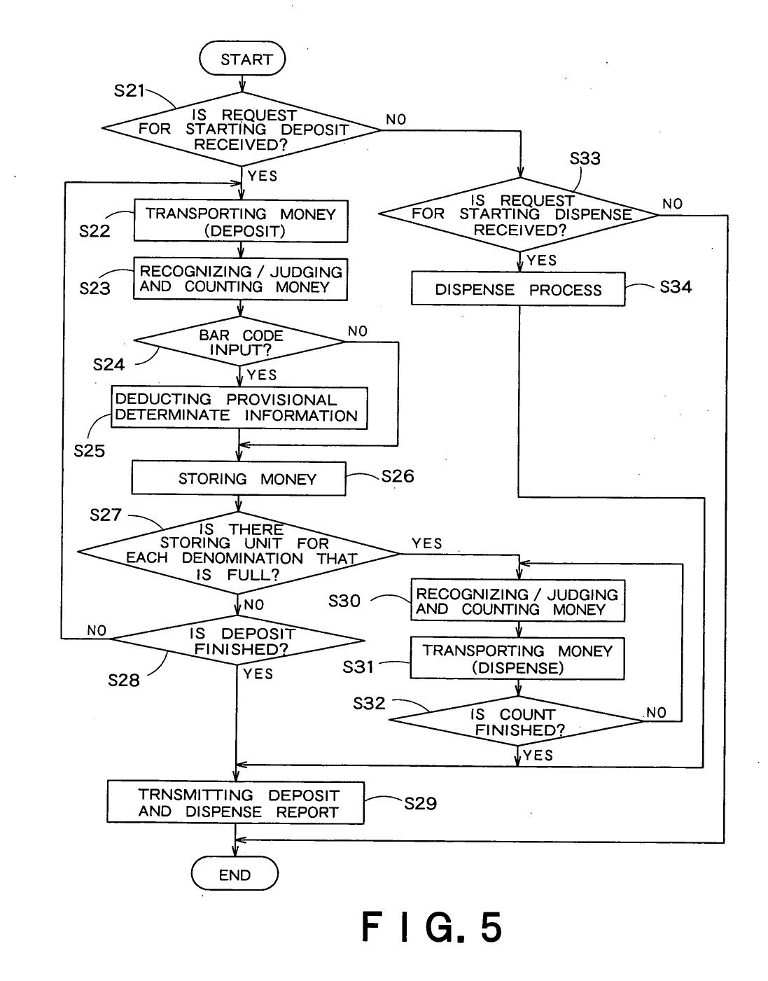

Next, processes to be performed in the deposit and dispense apparatus 1 as structured above when a person in charge performs the deposit operation and the dispense operation are described with reference to FIGS. 4 and 5.

A process to be performed by the main control unit 12 of the terminal 3 is firstly described with reference to a flowchart shown in FIG. 4. FIG. 4 is the flowchart showing the process performed by the main control unit 12. As long as electric power is supplied to the deposit and dispense apparatus 1, the main control unit 12 repeats a series of procedures (processes) shown in the flowchart of FIG. 4.

When the electric power is turned on to be supplied to the deposit and dispense apparatus 1, the main control unit 12 of the terminal 3 (hereinafter referred to simply as “main control unit 12”) performs a standby process (step S01). In the standby process, the main control unit 12 performs a process in which the display and operation unit 11 displays an image (see, FIG. 2(a)) as a standby image, by which one of the deposit process and the dispense process is selected by a person in charge. Then, the main control unit 12 advances the process to a step S02.

Then, in the step S02, the main control unit 12 judges whether an operation to start the deposit process (hereinafter referred to as “deposit operation”) has been performed or not.

When it is detected that a part where the characters “Deposit” are displayed in the standby image on the display and operation unit 11 is touched by the person in charge, the main control unit 12 judges that the deposit operation has been performed.

When it is judged that the deposit operation has been performed in the step S02 (step S02: Yes), the main control unit 12 advances the process to a step S03. On the other hand, when it is judged that the deposit operation has not been performed in the step S02 (step S02: No), the main control unit 12 advances the process to a step S15.

In the step S15, the main control unit 12 judges whether an operation to start the dispense process (hereinafter referred to as “dispense operation”) has been performed or not.

When it is detected that a part where the characters “Dispense” are displayed in the standby image on the display and operation unit 11 is touched by the person in charge, the main control unit 12 judges that the dispense operation has been performed.

When it is judged that the dispense operation has been performed in the step S15 (step S15: Yes), the main control unit 12 advances the process to a step S16 in which a process request including a request for starting the dispense is transmitted to the handling machine 2. Then, the main control unit 12 advances the process to a step S08. On the other hand, when it is judged that the dispense operation has not been performed in the step S15 (step S15: No), the main control unit 12 finishes the process.

In the step S03, the main control unit 12 performs a process in which the display and operation unit 11 displays an instruction display image (see, FIG. 2(b)) which requests an input of a deposit sum or an input of a bar code. Then, the main control unit 12 advances the process to a step S04.

Then, in the step S04, the main control unit 12 judges whether the person in charge has inputted, in the step S03, a sum of banknotes to be now deposited by means of the instruction image displayed and then has touched a part where the characters “Confirm” are displayed in the instruction image (has entered the confirmation), or not. When it is judged that the confirmation has been entered (step S04: Yes), the main control unit 12 advances the process to a step S05. On the other hand, when it is judged that the confirmation has not been entered (step S04: No), the main control unit 12 repeatedly performs the judgment in the step S04 until the person in charge enters the confirmation.

Then, in the step S05, the main control unit 12 judges whether it is possible to store all the banknotes corresponding to the deposit sum which has been confirmed in the step S04.

At this time, in the main control unit 12, the CPU refers to the RAM so as to calculate the number of banknotes for each denomination that can be stored in the storing units for each denomination 22 to 24 at present, based on the number of banknotes for each denomination (valuable media information) which has been counted by the recognition and judgment unit 28 during a time period from when banknotes together with the storing units for each denomination 22 to 24 were collected in the previous time until now.

When the number of banknotes for each denomination that can be now stored in the storing units for each denomination 22 to 24 is equal to or larger than the number of banknotes for each denomination corresponding to the confirmed deposit sum, the main control unit 12 judges that it is possible to store the banknotes (step S05: Yes), and advances the process to a step S06.

On the other hand, when the number of banknotes for each denomination that can be now stored in the storing units for each denomination 22 to 24 is smaller than the number of banknotes for each denomination corresponding to the confirmed deposit sum, the main control unit 12 judges that it is impossible to store the banknotes (step S05: No), and advances the process to a step S13.

In the step S13, the main control unit 12 performs a process in which the display and operation unit 11 displays an instruction display image (see, FIG. 2(e)), which informs that banknotes that cannot be stored in the storing units for each denomination 22 to 24 are returned after the deposit process is finished. Then, the main control unit 12 advances the process to the step S06.

In the step S06, the main control unit 12 performs a process in which the display and operation unit 11 displays an instruction display image (see, FIG. 2(c)), which recommends the person in charge to supply banknotes. Then, the main control unit 12 advances the process to a step S07.

In the step S07, when it is detected that banknotes have been supplied to the inlet 5, the main control unit 12 transmits a process request including a request for starting the deposit to the handling machine 2. Then, the main control unit 12 advances the process to a step S08.

In the step S08, the main control unit 12 judges whether a deposit and dispense report from the handling machine 2 has been received.

The deposit and dispense report transmitted from the handling machine 2 includes: information (determinate information) showing the number of banknotes for each denomination and a total sum thereof, the banknotes having been taken into the handling machine 2, subjected to the recognition and judgment process and the count process, and then put into the storing units for each denomination 22 to 24; information (provisional determinate information) showing the number of banknotes for each denomination and a total sum thereof, the banknotes having been taken into the handling machine 2, subjected to the recognition and judgment process and the count process, and then returned to the outside; and information showing the number of banknotes for each denomination and a total sum thereof, the banknotes having been dispensed from the handling machine 2.

In the step S08, when it is judged that a deposit and dispense report from the handling machine 2 has been received (step S08: Yes), the main control unit 12 advances the process to a step S09. On the other hand, when it is judged that a deposit and dispense report from the handling machine 2 has not been received (step S08: No), the main control unit 12 repeats the judgment in the step S08 until it receives a deposit and dispense report.

Then, in the step S09, the main control unit 12 judges whether the deposit and dispense report transmitted from the handling machine 2 includes the provisional determinate information or not. When it is judged that the provisional determinate information is included (step S09: Yes), the main control unit 12 advances the process to a step S14. On the other hand, when it is judged that the provisional determinate information is not included (step S09: No), the main control unit 12 advances the process to a step S10.

In the step S14, the main control unit 12 causes the RAM in the main control unit 12 to store the provisional determinate information, and then advances the process to a step S17.

Then, in the step S17, the main control unit 12 performs a process in which the provisional determinate information stored in the RAM is converted to a bar code, and a bar code seal 13c on which the bar code is printed is issued. Then, the main control unit 12 advances the process to the step S10.

In the step S10, the main control unit 12 causes the RAM in the main control unit 12 to store the determinate information included in the deposit and dispense report transmitted from the handling machine 2. Then, the main control unit 12 advances the process to a step S11.

Then, in the step S11, the main control unit 12 performs a process in which the display and operation unit 11 displays a confirmation display image, by which the person in charge can confirm a total sum of the banknotes that have been deposited and dispensed.

At this time, when all the banknotes supplied by the person in charge have been stored, the main control unit 12 causes the display and operation unit 11 to display a confirmation image (see, FIG. 2(d)) showing the total sum thereof. On the other hand, when a part of the banknotes supplied by the person in charge has been stored but the other part of the banknotes could not be stored and has been returned, the main control unit 12 causes the display and operation unit 11 to display a confirmation image (see, FIG. 2(f)) showing a total sum (determinate deposit sum) of the stored banknotes and a total sum (provisional determinate deposit sum) of the returned banknotes.

Thereafter, the main control unit 12 advances the process to a step S12, and judges whether a confirmation operation has been performed or not. When it is detected that the person in charge has touched a part where the characters “Confirm” are displayed in the confirmation image (see, e.g., FIG. 2(e) and FIG. 2(f)), the main control unit 12 judges that the confirmation operation has been performed. On the other hand, when it is not detected that the person in charge has touched the part where the characters “Confirm” are displayed, the main control unit 12 judges that the confirmation operation has not been operated.

When it is judged that the confirmation operation has been performed (step S12: Yes), the main control unit 12 finishes the process. On the other hand, when it is judged that the confirmation operation has not been performed (step S12: No), the main control unit 12 repeats the judgment in the step S12 until the confirmation operation is performed.

In the aforementioned process(es) performed by the main control unit 12, the bar code seal 13c is issued (step S17), after the provisional determinate information has been recorded (step S14). However, the issuance of the bar code seal 13c may be performed after the confirmation operation has been performed (step S12: No).

In addition, the main control unit 12 causes the display and operation unit 11 to display only the total sum in the confirmation display image (see, e.g., FIG. 2(e) and FIG. 2(f)), by which the person in charge can confirm the total sum of the banknotes that have been deposited and dispensed. However, the number of banknotes for each denomination, which have been deposited and dispensed, may also be displayed in addition to the total sum.

Next, a process to be performed by the sub control unit 21 that controls the handling machine 2 of the deposit and dispense apparatus 1 is described with reference to FIG. 5. FIG. 5 is a flowchart showing the process performed by the sub control unit 21 of the handling machine 2.

As long as electric power is supplied to the deposit and dispense apparatus 1, the sub control unit 21 of the handling machine 2 repeats a series of procedures (processes) shown in the flowchart of FIG. 5.

As shown in FIG. 5, when the electric power is turned on to be supplied to the handling machine 2, the sub control unit 21 of the handling machine 2 (hereinafter referred to simply as “sub control unit 21”) firstly judges whether a process request including a request for starting the deposit transmitted from the terminal 3 has been received or not (step S21).

In the step S21, when it is judged that the process request including the request for starting the deposit has been received (step S21: Yes), the sub control unit 21 advances the process to a step S22. On the other hand, when it is judged that the process request has not been received (step S21: No), the sub control unit 21 advances the process to a step S33.

In the step S33, the sub control unit 21 judges whether a process request including a request for starting the dispense has been received or not. When it is judged that the process request including the request for starting the dispense has been received (step S33: Yes), the sub control unit 21 performs a dispense process for dispensing banknotes in response to the request for starting the dispense (step S34). Then, the sub control unit 21 advances the process to a step S29. On the other hand, when it is judged that the process request including the request for starting the dispense has not been received (step S33: No), the sub control unit 21 finishes the process.

In the step S22, the sub control unit 21 performs the following processes (step 23). Namely, the sub control unit 21 performs a process (taking-in process) in which banknotes supplied by a person in charge are taken one by one and transported to the inside. Thereafter, the sub control unit 21 performs a process (recognition and judgment process) in which an authentification, a fitness and a denomination of the respective banknotes taken to the inside are recognized and judged. Thereafter, the sub control unit 21 performs a process (count process) in which the number of banknotes for each denomination is counted and a total sum thereof is calculated, the banknotes having been subjected to the recognition and judgment process.

The recognition and judgment process and the count process are performed for each time when a banknote is transported to the recognition and judgment unit 28, and are continued until all the banknotes supplied by the person in charge are subjected to the recognition and judgment process and the count process.

Then, in a step S24, the sub control unit 21 judges whether the request for starting the deposit, which has been received in the step S21, is a request inputted through a bar code or not. That is to say, in the step S24, the sub control unit 21 judges whether or not the banknotes taken to the inside at this time are banknotes which could not be stored in the storing units for each denomination 22 to 24 and were returned in the precedent deposit operation (banknotes corresponding to the provisional determinate information), and are supplied again.

When the main control unit 12 judges that the provisional determinate information read out through the bar code reader 13a and the provisional determinate information stored in the RAM inside the main control unit 12 are identical to each other, the main control unit 12 transmits the request for starting the deposit inputted through the bar code to the sub control unit 21.

When it is judged that the request for starting the deposit, which has been received in the step S21, is a request inputted through a bar code (step S24: Yes), the sub control unit 21 performs a process in which a counted value of the resupplied banknotes corresponding to the provisional determinate information is deducted (deleted) from the result of the count process performed in the step S23. Then, the sub control unit 21 advances the process to a step S26.

On the other hand, when it is judged that the request for starting the deposit, which has been received in the step S21, is not a request inputted through a bar code (step S24: No), the sub control unit 21 advances the process to the step S26.

In the step S26, the sub control unit 21 performs a process in which the banknotes, which have been subjected to the recognition and judgment process and the count process, are sequentially put into the storing units for each denomination 22 to 24. Then, the sub control unit 21 advances the process to a step S27.

Then, in the step S27, the sub control unit 21 judges whether or not one or more of the storing unit(s) for each denomination 22 to 24 is (are) full or nearly full of banknotes. When it is judged that there is (are) the full storing unit(s) for each denomination (step S27: Yes), the sub control unit 21 advances the process to a step S30. On the other hand, when it is judged that there is no full storing units for each denomination (step S27: No), the sub control unit 21 advances the process to a step S28.

In the step S28, the sub control unit 21 judges whether the deposit has been completed or not. When all the banknotes supplied to the handling machine 2 are taken thereinto and stored, the sub control unit 21 judges that the deposit has been completed.

When it is judged that the deposit has been completed (step S28: Yes), the control unit 21 advances the process to a step S29. On the other hand, when it is judged that the deposit has not been completed (step S28: No), the sub control unit 21 returns the process to the step S22.

In the step S30, the sub control unit 21 performs a process in which the banknotes, which cannot be stored in the storing units for each denomination 22 to 24, out of the banknotes taken to the inside, are sequentially subjected to the recognition and judgment process and the count process. Thereafter, the sub control unit 21 performs a process in which the banknotes, which have been subjected to the recognition and judgment process and the count process in the step S30, are transported to be returned to the outside (step S31).

Then, in a step S32, the sub control unit 21 judges whether the count has been completed or not. When the recognition and judgment process and the count process to the banknotes, which have been taken to the inside after any of the storing units 22 to 24 became full, are completed, the sub control unit 21 judges that the count has been completed.

When it is judged that the count has been completed (step S32: Yes), the sub control unit 21 advances the process to a step S29. On the other hand, when it is judged that the count has not been completed (step S32: No), the sub control unit 21 returns the process to the step S30.

Finally, in the step S29, the sub control unit 21 transmits a deposit and dispense report to the terminal 3 so as to finish the process.

When all the supplied banknotes are stored in the deposit process, the deposit and dispense report transmitted at this time includes information showing the number of the banknotes for each denomination and a total sum thereof (determinate information). When a part of the banknotes out of all the supplied banknotes is stored and the other part of the banknotes that could not be stored is returned, the deposit and dispense report transmitted at this time includes information showing the number of the stored banknotes for each denomination and a total sum thereof (determinate information) and information showing the number of the returned banknotes for each denomination and a total sum thereof (provisional determinate information).

When the handling machine 2 performs the dispense process, the deposit and dispense report includes information showing the number of banknotes for each denomination and a total sum thereof, the banknotes having been dispensed from the handling machine 2.

In this embodiment, the bar code seal 13c on which the provisional determinate information has been printed as a bar code is issued. However, the recording medium recording the provisional determinate information is not limited to the bar code seal 3c, and an IC tag recording the provisional determinate information may be used.

When such a structure is employed, it is necessary to provide, instead of the bar code reader 13a, a recording unit for recording the provisional determinate information on the IC tag, an IC-tag issuing unit for issuing the IC tag recording the provisional determinate information, and a provisional-determinate information reading unit for reading the provisional determinate information from the issued IC tag.

The aforementioned respective information processing programs are not necessarily stored in the ROM from the first. The respective information processing programs may be stored in: a “movable physical medium” such as a flexible disc (FD), a CD-ROM, an MO disc, a DVD disc, a magnetoptical disc, or an IC card, which can be inserted to respective terminals and the respective deposit and dispense apparatuses; a “stationary physical medium” such as a hard disc drive (HDD) which can be installed inside or outside the respective terminals and the respective deposit and dispense apparatuses; or “another computer (or a server)” to be connected to the respective terminals and the respective deposit and dispense apparatuses through a public circuit, an internet, a LAN or a WAN. The respective information processing programs stored in such media or computer may be read by the computer and executed.

Out of the respective processes described in this embodiment, a part of or all of the processes which are described as the automatic processes may be manually performed. Alternatively, a part of or all of the processes which are described as the manual processes may be automatically performed by a known method. Moreover, unless otherwise specified, the process procedure, the control procedure, the concrete names, and the information including various data and parameters, may be optionally changed.

Further, the illustrated respective constituent elements of the apparatuses are functional and conceptual, and it is not necessary that the constituent elements are physically structured as the illustration. Namely, the concrete form of dispersion and integration of the respective apparatuses is not limited to the illustrated examples, but all or one of the apparatuses can be functionally or physically dispersed and integrated at optional unit in accordance with various loads and used conditions. Furthermore, all or an optional part of the respective process functions performed in the respective apparatuses may be realized by a CPU and an information processing program that is analyzed and executed by the CPU, or may be realized as a hardware by a wired logic.

1. A valuable media handling apparatus for processing valuable media, comprising:
a taking-in unit configured to take valuable media supplied from outside into the apparatus;
a storing unit configured to store the valuable media taken by the taking-in unit;
a detecting unit configured to detect that the storing unit becomes full or nearly full of valuable media;
a returning unit configured to return, when the fact that the storing unit has become full or nearly full of valuable media is detected by the detecting unit in the course of the taking-in operation by the taking-in unit, the valuable media which are taken by the taking-in unit after the detection, to the outside of the apparatus;
an information obtaining unit configured to obtain valuable media information about the valuable media taken by the taking-in unit; and
an information managing unit configured to manage, as determinate information, the valuable media information about the valuable media which have been taken during a time period from a start of the taking-in operation by the taking-in unit until the detection by the detecting unit, and to manage, as provisional determinate information, the valuable media information about the valuable media which have been returned by the returning unit.

2. The valuable media handling apparatus according to claim 1, wherein
the information managing unit includes a memory unit configured to store the valuable media information obtained by the information obtaining unit, and
the information managing unit causes the memory unit to store the determinate information and the provisional determinate information.

3. The valuable media handling apparatus according to claim 2, wherein
the valuable media information is information including the number and types of the valuable media taken by the taking-in unit.

4. The valuable media handling apparatus according to claim 2, wherein
the valuable media information is information including a total sum or a total value of the valuable media taken by the taking-in unit.

5. The valuable media handling apparatus according to claim 1, comprising a recording medium issuing unit configured to issue a recording medium recording the provisional determinate information.

6. The valuable media handling apparatus according to claim 5, comprising:
a provisional-determinate-information reading unit configured to read the provisional determinate information from the recording medium issued by the recording medium issuing unit; and
a deleting unit configured to, when the provisional determinate information read by the provisional-determinate-information reading unit and the provisional determinate information stored in the memory unit are identical to each other and when valuable media corresponding to the provisional determinate information are taken by the taking-in unit, delete the valuable media information obtained about the taken-in valuable media.

7. The valuable media handling apparatus according to claim 1, comprising:
a recording medium issuing unit configured to issue a recording medium recording identification information for identifying the provisional determinate information; and
an identification-information reading unit configured to read the identification information from the recording medium issued by the recording medium issuing unit;
wherein the information managing unit is configured to delete at least a part of or all the information of the valuable media, out of the provisional determinate information corresponding to the identification information read by the identification-information reading unit.

8. A valuable media handling method comprising the steps of:
taking valuable media supplied from outside into an apparatus;
obtaining valuable media information about the valuable media taken into the apparatus;
putting the valuable media taken into the apparatus into a storing unit;
detecting that the storing unit becomes full or nearly full of valuable media;
returning, when it is detected that the storing unit has become full or nearly full of valuable media in the course of taking the valuable media, the valuable media which are taken into the apparatus after the detection, to the outside of the apparatus;
managing, as determinate information, the valuable media information about the valuable media which have been taken during a time period from a start of the taking-in operation of the valuable media until the fact that the storing unit has become full or nearly full of valuable media is detected, and
managing, as provisional determinate information, the valuable media information about the returned valuable media.
